(19) United States
(12) Patent Application Publication
(10) Pub. No.: US 2018/0070577 A1
(43) Pub. Date: Mar. 15, 2018

(54) Bird Saver Light

(71) Applicant: Stephens Smith Farrell, Asheville, NC (US)

(72) Inventor: Stephens Smith Farrell, Asheville, NC (US)

(21) Appl. No.: 15/265,315

(22) Filed: Sep. 14, 2016

(51) Int. Cl. A01M 29/10; F21K 99/00

(52) U.S. Cl. CPC A01M 29/10; F21K 99/00

(57) ABSTRACT

Bird Saver Light prevents or minimizes bird collisions with glazing.
BSL is deployable from within a building.
BSL operates on the critical Fourth Surface of insulated glazing units.
BSL avoids warranty issues associated with films and appliqués.
BSL is potentially critical in protecting wild bird populations.

Table of Contents

```
  1. Title of Invention
  2. Cross Reference to Related Applications
  3. Statement Regarding Federally Sponsored Research or Development
  4. Reference to a “Sequence Listing” (if Applicable)
  5. Background of the Invention
  6. Brief Summary of the Invention
  7. Brief Summary of the Drawings
  8. Detailed Description of the Invention
  9. Claim or Claims
10. Abstract of the Disclosure
```

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO A ‘SEQUENCE LISTING” (IF APPLICABLE)

Not Applicable

### BACKGROUND OF THE INVENTION

Millions of birds are killed, injured, or disoriented each year from collisions with window glass (glazing). Birds cannot perceive the presence of glazing and/or misinterpret the reflections in glazing as open sky.

Populations of wild birds are in catastrophic decline due to glazing collisions, urban light disorientation, house cats, and habitat loss.

It is estimated that bird collisions with glazing account over half of all human induced bird fatalities (including house cat fatalities).

Disorientation due to glancing (non direct) collisions leaves birds vulnerable to ground predators.

Birds' eyesight extends into ultraviolet spectrums not perceivable to humans. By exploiting this difference it is possible to project ultraviolet light and ultraviolet “shadows” in patterns clearly discernable to birds but invisible to humans.

Prior art in glazing technology is either limited to new construction or glazing replacement (and is prohibitively expensive) or is architecturally undesirable (visible to humans) and/or dangerous or impractical.

Other prior art in bird collision avoidance involves stickers or decals adhered to the exterior surface of the window; these temporary remedies involve gaining access to the exterior of the glazing and are dangerous and/or unfeasible options in many applications. They may also void glazing warranties.

### BRIEF SUMMARY OF THE INVENTION

Bird Saver Light (BSL) solves the critical problem of bird collisions with glazing by projecting an ultraviolet light source through a filter that then projects an ultraviolet light and ultraviolet “shadows”, clearly visible to birds but invisible to humans, onto the glazing. These patterns signal opaqueness to birds that then can avoid fatal or injurious collisions.

### BRIEF DESCRIPTION OF THE DRAWINGS

FIG. 1 shows the components of the design in section and in context with an existing or proposed (new construction) glazing unit

FIG. 2 shows an axonometric diagram of the ultraviolet filter

FIG. 3 shows an elevation of what both a human and a bird see on a glazing unit without BSL

FIG. 4 shows an elevation of what a bird sees on a glazing unit with BSL

FIG. 5 shows what a human sees on a glazing unit with BSL

FIG. 6 shows the relative range of visible light perception for humans and birds

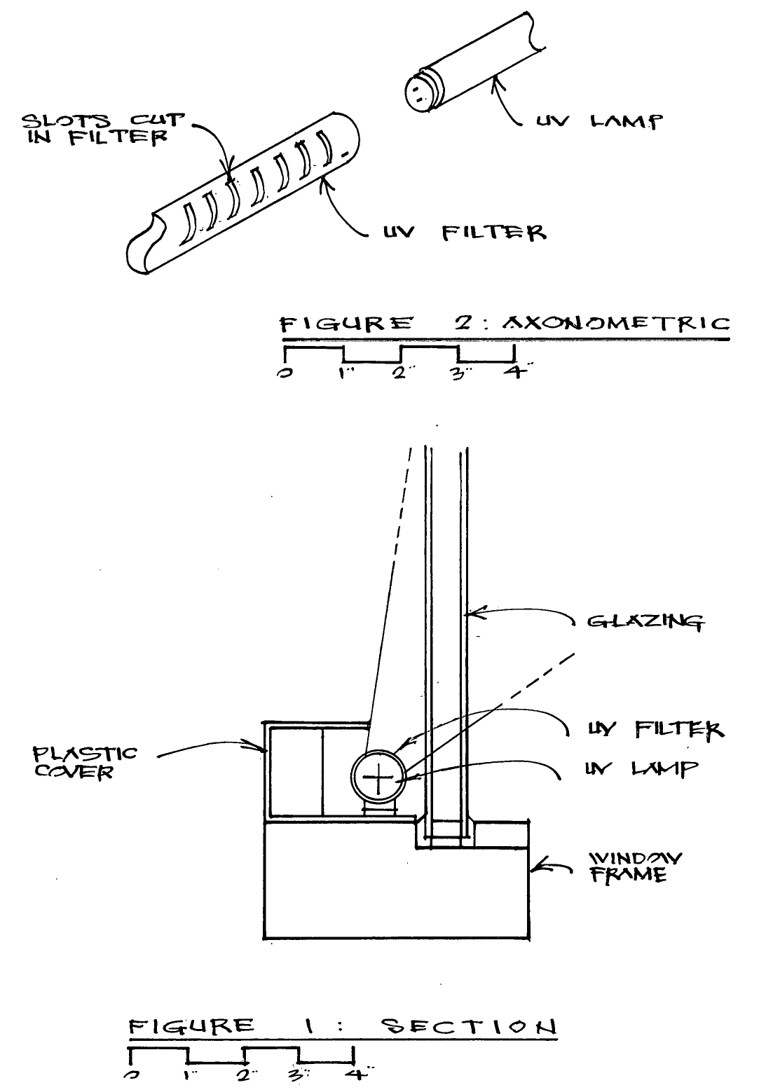

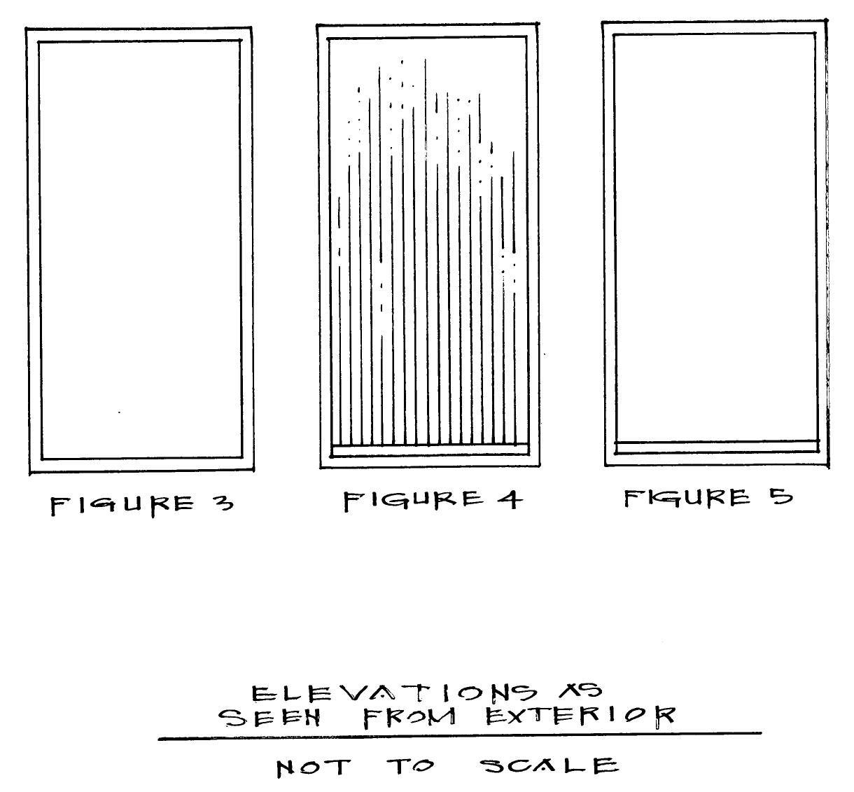

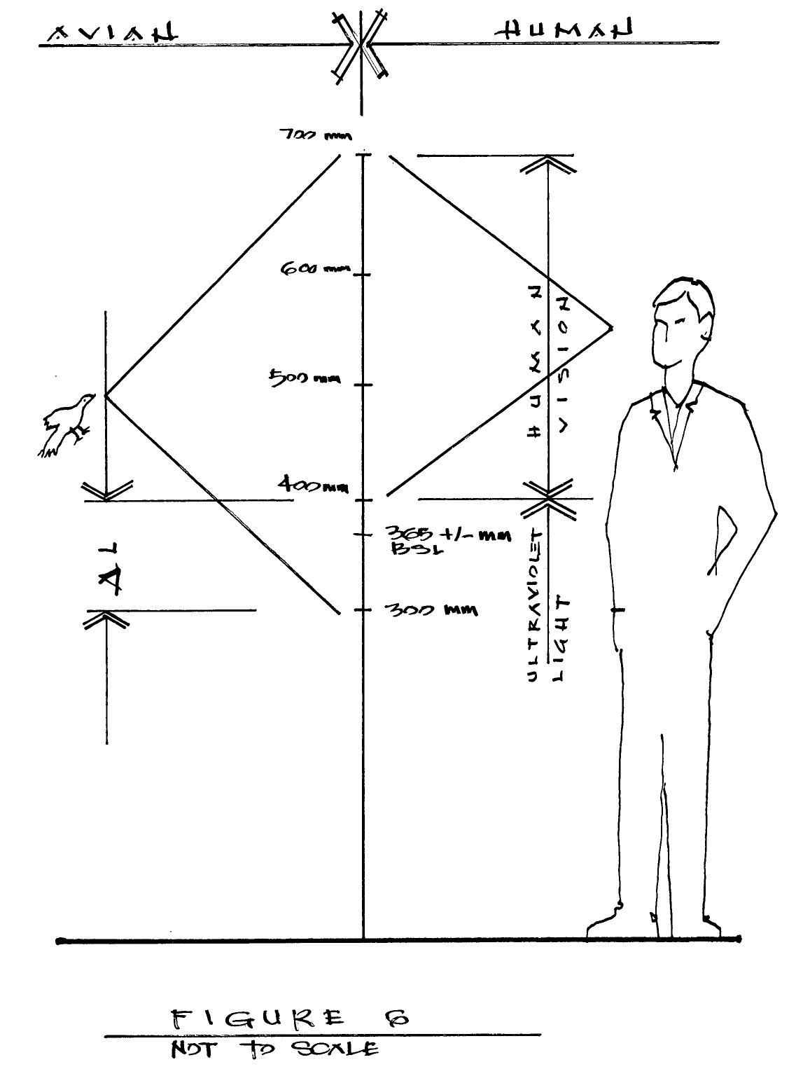

### DETAILED DESCRIPTION OF THE INVENTION

Humans perceive light wavelinks from approximately 400 millimeters (mm) to approximately 700 mm.

As a result of the unique anatomy of a birds eye's they are able to perceive light in wavelinks from approximately 300 mm to 700 mm.

Light in wavelinks between 300 and 400 mm are referred to as ultraviolet or more specifically in this range as Ultraviolet A or UVA.

Ultraviolet B and Ultraviolet C (UVB and UVC respectively) are below 300 mm and are visible to neither birds nor humans.

By projecting ultraviolet light of approximately 365 mm in wavelink through an ultraviolet filter the BSL cast ultraviolet light and ultraviolet “shadows” onto the glazing surface in patterns clearly discernable to birds but invisible to humans.

BSL is equally adaptable to existing or proposed construction. BSL is comparatively cost effective compared to prior art glazing technologies.

BSL is easily and safely deployed from within the glazing unit, eliminating the costly or dangerous requirement of temporary exterior applications.

1. Projecting ultraviolet light and ultraviolet “shadows” onto glazing surfaces prevents or drastically reduces bird/glazing collisions.
Working within a building or structure is preferable from a safety and convenience perspective; BSL operates from within buildings or structures.
Ultraviolet A light and UVA shadow projection systems are preferable to costly glazing UV integrated systems.
Under any scenario it is imperative that the bird glazing avoidance system operate on the exterior glazing surface (surface 4 of dual pane insulated glazing) to prevent so-called veiling reflections; BSL projects onto all surface of insulated and un-insulated glazing units (referred to as surfaces 1, 2, 3, and 4 on insulated glazing). Surface 4 is the exterior surface of insulated glazing units.
Films and decals may void the warranty of insulated glazing units. BSL avoids warranty issues.
